(19) United States
(12) Patent Application Publication
(10) Pub. No.: US 2025/0196604 A1
(43) Pub. Date: Jun. 19, 2025

(54) ELECTRIC VEHICLE

(71) Applicant: TOYOTA JIDOSHA KABUSHIKI KAISHA, Toyota-shi (JP)

(72) Inventors: Takahiro UCHIDA, Kasugai-shi (JP); Seiji ARAKAWA, Nisshin-shi (JP); Kazuhito SAKAI, Mishima-shi (JP); Chie FUKUHARA, Toyota-shi (JP)

(73) Assignee: TOYOTA JIDOSHA KABUSHIKI KAISHA, Toyota-shi (JP)

(21) Appl. No.: 18/984,433

(22) Filed: Dec. 17, 2024

(30) Foreign Application Priority Data
Dec. 19, 2023 (JP) 2023-213827

(51) Int. Cl. B60K 1/00; B60L 50/60

(52) U.S. Cl. CPC B60K 1/00; B60L 50/60; B60L 2270/145

(57) ABSTRACT

An electric vehicle includes a vibration generator mounted on a vehicle body via a vibration damping member. The electric vehicle also includes a vibration transmission path extending from the vibration generator to the vehicle body, without pathing through the vibration damping member. Vibration generated in the vibration generator is transmitted to the vehicle body at a moderate level. This enables the driver to perceive the vibration and sound comfortably. The driver's discomfort caused by the vibration and sound of the electric vehicle can be relieved.

### CROSS-REFERENCE TO RELATED APPLICATION

This application claims priority to Japanese Patent Application No. 2023-213827 filed on Dec. 19, 2023, the entire contents of which are incorporated by reference herein.

### TECHNICAL FIELD

The present disclosure relates to electric vehicles.

### BACKGROUND ART

Patent Literature 1 discloses a vehicle that is driven by a rotational force output from a motor. The vehicle includes a motor that outputs rotational force, a reduction gear unit that transmits the rotational force of the motor to drive wheels, and a vibration component that generates vibration. The motor and the reduction gear unit are connected to form a driving device unit, and the vibration component is attached to the driving device unit.

### LIST OF RELATED ART

Patent Literature 1: Japanese Patent Application Laid-Open No. 2020-114717

### SUMMARY

In general, it is preferable that vibration transmission in vehicles is as small as possible. As the vibration transmission is smaller, noise caused by the vibration can be suppressed. Electric vehicles are superior to engine vehicles in quietness, but electric vehicles also have problems related to sounds such as high-frequency sound of motors, road noise, wind noise, etc. Drivers may feel these types of sounds uncomfortable.

An object of the present disclosure is to provide a technique for eliminating the driver's discomfort caused by vibrations and sounds of electric vehicles.

A first aspect relates to an electric vehicle.

The electric vehicle includes:
a vibration generator mounted on a vehicle body via a vibration damping member; and
a vibration transmission path extending from the vibration generator to the vehicle body, without passing through the vibration damping member.

According to the aspect of the present disclosure, the electric vehicle includes the vibration transmission path that does not pass through the vibration damping member. Thus, vibration of a moderate level is transmitted to the vehicle body. This enables the driver to perceive the vibration of the moderate level as sound with moderate sound pressure and frequency. As a result, the driver's discomfort caused by the vibration and sound of the electric vehicle can be relieved.

### BRIEF DESCRIPTION OF DRAWINGS

FIG. 1 is a schematic diagram of an electric vehicle;

FIG. 2 is a schematic diagram showing a positional relation between a vehicle body and a vibration generator;

FIG. 3 is a schematic diagram showing a variation of a vibration transmission path;

FIG. 4 is a schematic diagram showing another variation of the vibration transmission path;

FIG. 5 is a schematic diagram for explaining a switching part in the vibration transmission path;

FIG. 6 is a schematic diagram showing a configuration in which a vibrator is installed on the body of the electric vehicle having an MT mode.

### DETAILED DESCRIPTION

Embodiments of the present disclosure will be described with reference to the drawings.

### 1. Vibration of Electric Vehicle

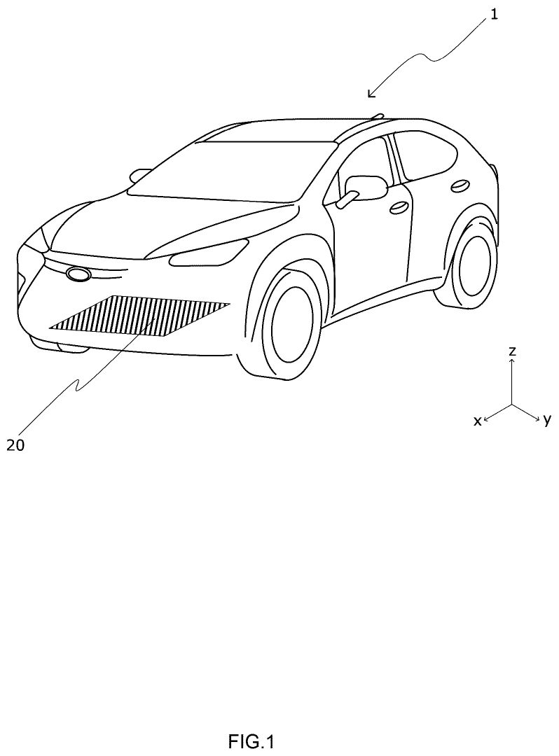

FIG. 1 is a schematic diagram of an electric vehicle 1. Examples of the electric vehicle 1 include various types of vehicles such as a BEV, a PEV, and an HEV. The x-axis direction in the drawing corresponds to the forward direction of the electric vehicle 1. The y-axis direction corresponds to the left direction from the driver's viewpoint of the electric vehicle 1, and the z-axis direction corresponds to the upward direction of the electric vehicle 1.

A powertrain (components necessary for rotating drive wheels) of the electric vehicle 1 includes a battery that charges and discharges electric power, an inverter that controls the electric power, a motor that converts the electric power into a rotational force, etc.

The inverter converts a direct current supplied from the battery into an alternating current. The alternating current is required to rotate the motor. These components of the powertrain generate vibrations while they are activated. The vibration is transmitted through the air or the vehicle body and is perceived as sound by the driver or a passenger of the electric vehicle 1.

An integrated unit of the inverter, the motor, etc. is called an e-axle. Generally, e-axles are mounted on a vehicle as a ready-made product. E-axles, in which the parts generating vibration are integrated, also generate vibration. The electric vehicle 1 includes a vibration generator 20 such as an e-axle. In the present embodiment, the vibration generator 20 is described as an e-axle. The vibration generator 20 is not limited to an e-axle as long as it generates vibration. For example, a compressor for an air conditioner also corresponds to the vibration generator 20.

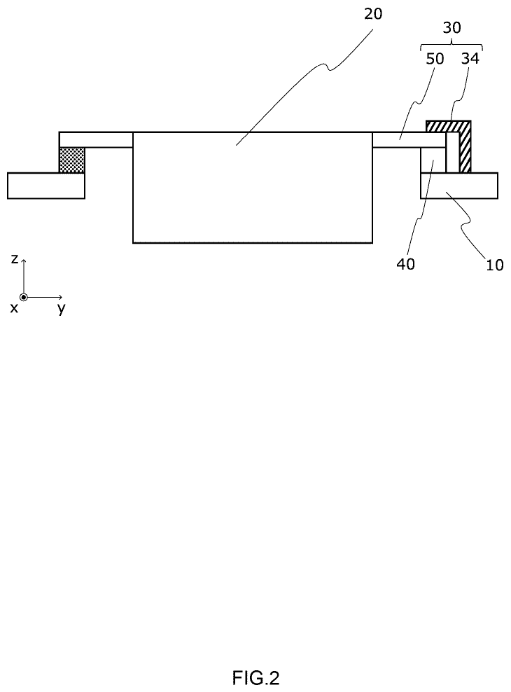

FIG. 2 is a schematic diagram showing a positional relation between a vehicle body 10 and the vibration generator 20.

The vibration generator 20 is mounted on the vehicle body 10 via a vibration damping member 40 for damping vibration. The vibration damping member 40 is an elastic body such as rubber. The vibration generator 20 is, for example, an e-axle. The electric vehicle 1 further includes a mount bracket 50 that connects the vibration generator 20 and the vibration damping member 40. The mount bracket 50 is typically made of metal and is mechanically joined to the vibration generator 20 with bolts, nuts, etc. The mount bracket 50 is fixed to the vehicle body 10 with bolts, nuts, etc. so that the vibration damping member 40 is sandwiched by the mount bracket 50 and the vehicle body 10. In the figure, the vehicle body 10 is illustrated as a vehicle frame.

The electric vehicle 1 includes a vibration transmission path 30. The vibration transmission path 30 is formed of a solid, not an air layer. For example, the vibration transmission path 30 includes a vibration transmission bracket 34. The vibration transmission bracket 34 connects the mount bracket 50 and the vehicle body 10. That is, the vibration transmission path 30 extends from the vibration generator 20 to the vehicle body 10 via the mount bracket 50 and the vibration transmission bracket 34. The vibration transmission bracket 34 is made of, for example, a metal plate, and is fixed to the mount bracket 50 and the vehicle body 10 by a mechanical joint with bolts, nuts, etc.

The vibration generated in the vibration generator 20 is transmitted to the vehicle body 10 by being divided into a path passing through the mount bracket 50 and the vibration damping member 40 and the vibration transmission path 30 without passing through the vibration damping member 40. When the vibration is transmitted to the vehicle body 10 via the vibration damping member 40, which means the vibration is transmitted to the vehicle body 10 via the vibration damping member 40, the vibration level is attenuated in the process of the vibration transmission to the vehicle body 10. On the other hand, the vibration transmitted to the vehicle body 10 through the vibration transmission path 30 is transmitted via the mount bracket 50 and the vibration transmission bracket 34 (without passing through the vibration damping member 40). Therefore, the vibration level transmitted to the vehicle body 10 is less attenuated than that in the case where the vibration is transmitted through the vibration damping member 40.

### 2. Problems and Effects

In general, it is preferable that the vibration transmission of the vehicle is as small as possible, and the sound caused by the vibration can be suppressed as the vibration transmission is small. Since motors generate less vibration and sound than engines, electric vehicles are superior in quietness to engine vehicles. However, electric vehicles also have problems related to vibrations and sounds caused by vibrations. For example, high-frequency noise generated from a magnetic material in a motor in accordance with the switching frequency of an inverter is a problem specific to electric vehicles. There is also a problem due to the quietness of electric vehicles. For example, noise that is not noticeable in engine vehicles, such as road noise generated when tires roll on a road surface or wind noise generated when a vehicle travels through air, is conspicuously heard due to the quietness of electric vehicles. These sounds are not problematic in engine vehicles, since engines generate louder noises. These sounds may be perceived uncomfortable especially when a driver who has been driving an engine vehicle changes the engine vehicle to an electric vehicle.

Therefore, in the present disclosure, in order to solve the problem (the driver's discomfort) caused by the vibration and the sound of the electric vehicle 1, the vibration transmission path 30, which does not pass through the vibration damping member 40, is installed. Thus, vibration at a moderate level is transmitted to the vehicle body 10. The vibration at a moderate level is perceived by the driver as a sound with moderate sound pressure and frequency. This can relieve the driver's discomfort related to the vibration and sound of the electric vehicle 1. Further, changing the material, dimensions, arrangement, etc. of the vibration transmission bracket 34 can adjust the resonance frequency and the frequency characteristics of the sound to be perceived.

In addition, when the vibration generator 20 includes a motor that drives the electric vehicle 1, the magnitude and frequency of the vibration caused by the motor change in conjunction with the rotational speed of the motor, in other words, the speed of the electric vehicle 1. Therefore, the sound pressure and frequency of the sound generated from the vibration transmitted to the vehicle body 10 via the vibration damping member 40 also change in conjunction with the speed of the electric vehicle 1. Therefore, the sound pressure and the frequency of the sound perceived by the driver change in conjunction with the speed of the electric vehicle 1, that is, an accelerator operation by the driver. As a result, the driver can feel as if he or she were driving an engine vehicle.

The electric vehicle 1 may have an “MT mode” in which a manual gear shift operation and driving characteristics of a manual transmission vehicle (MT vehicle) can be reproduced in a pseudo manner (for example, see Japanese Patent No. 6787507). In this case, the electric vehicle 1 includes a pseudo-operation member (for example, a pseudo shift device or a pseudo clutch pedal) for reproducing the manual gear shift operation of the MT vehicle in a pseudo manner. In the MT mode, the driver of the electric vehicle 1 can drive the electric vehicle 1 as if the driver were driving an MT vehicle by operating the pseudo-operation member. Further, the sound caused by the vibration generator 20 and the vibration transmission path 30 changes in conjunction with the accelerator operation by the driver. Since the sound is also reproduced in a pseudo manner together with the driving operation of the “imaginary” MT vehicle, the driver can more strongly feel as if he or she were driving an MT vehicle.

### 3. Variations

### 3-1. Variations of Vibration Transmission Path

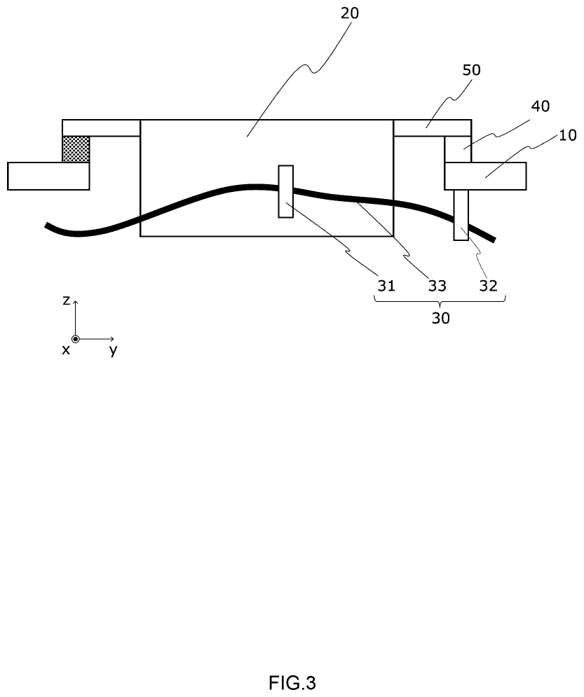

FIG. 3 is a schematic diagram showing a variation of the vibration transmission path 30. The vibration transmission path 30 includes a vibration transmission member 33, a first connector 31, and a second connector 32. The first connector 31 connects the vibration transmission member 33 and the vibration generator 20. The second connector 32 connects the vibration transmission member 33 and the vehicle body 10 (vehicle frame). The vibration generated by the vibration generator 20 is transmitted to the vehicle body 10 via the first connector 31, the vibration transmission member 33, and the second connector 32.

Here, it is assumed that a wire harness (wires or cables running throughout a vehicle) functions as the vibration transmission member 33. The wire harness connects electric/electronic devices mounted on a vehicle. In particular, an electric vehicle, using a motor as a power source, requires a wire harness for high voltage to supply a high voltage from a battery to the motor. The first connector 31 and the second connector 32 are metal components and are mechanically joined to the connecting target with bolts, nuts, etc. As shown in the example of FIG. 2, the vibration and the sound can be adjusted by changing the dimensions, the materials, and the connection positions of each component.

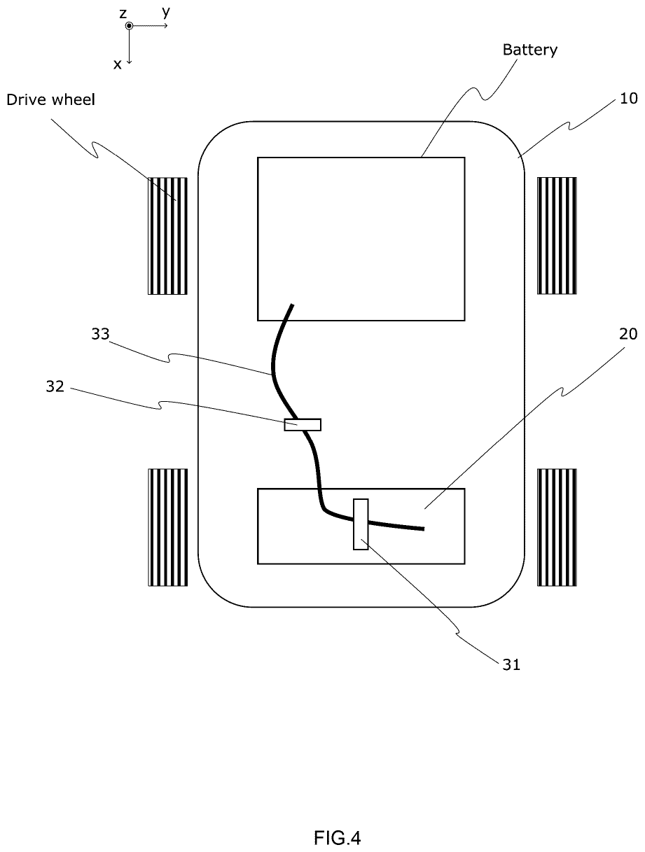

FIG. 4 is a schematic diagram showing another variation of the vibration transmission path 30. Here, as shown in the example of FIG. 3, the vibration transmission member 33 (wire harness), the first connector, and the second connector are used. The difference from the example of FIG. 3 is that the second connector 32 connects the vibration transmission member 33 and the body (sheet metal part). For example, by attaching the second connector 32 near the driver's seat, vibration and sound can be transmitted more directly to the driver. The vibration transmission bracket 34 shown in FIG. 2 and the vibration transmission member 33 shown in FIGS. 3 and 4 may be used in combination.

### 3-2. Switching of Vibration Transmission Path

If the function of the vibration transmission path 30 can be switched on and off, the driver can more flexibly customize the sound and vibration environment of the electric vehicle 1.

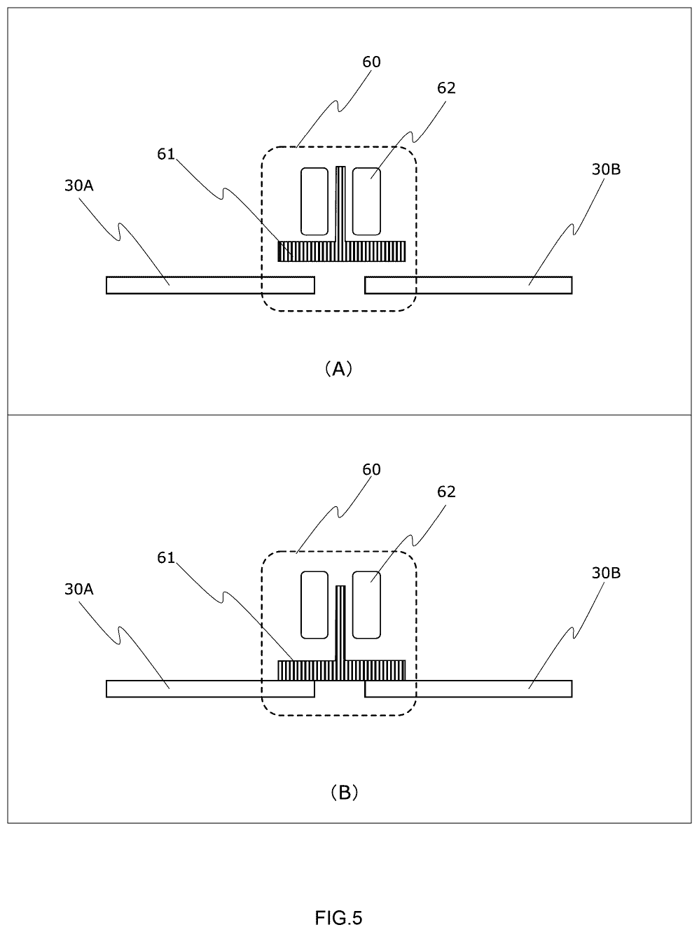

FIG. 5 is a schematic diagram for explaining a switching unit 60 in the vibration transmission path 30. The vibration transmission path 30 is divided into a first part 30A and a second part 30B. The first part 30A and the second part 30B are not in contact with each other. A coupling member 61 having a T-shaped cross section is provided near the two coils 62. The coupling member 61 is a magnetic body and is a movable body that moves in accordance with a current flowing through the coils 62. The current flowing through the coils 62 is controlled, and part A of FIG. 5 shows a state in which the control signal is OFF (a first state). In this state, the coupling member 61 is in contact with neither the first part 30A nor the second part 30B. On the other hand, part B of FIG. 5 shows a state in which the control signal is ON (a second state). In this state, the coupling member 61 is in contact with both the first part 30A and the second part 30B. That is, in the first state, the vibration transmission path 30 is kept disconnected, and thus the vibration is not transmitted. However, in the second state, the vibration transmission path 30 is connected via the coupling member 61, and thus the vibration can be transmitted. The method for realizing the switching unit 60 is not limited to the method using the coils 62 and the magnetic body (the coupling member 61). For example, another variation in which the first state and the second state are switched by a mechanical switch may be employed.

A configuration in which the switching unit 60 is introduced to the embodiments described above will be described. In the example of FIG. 2, the vibration transmission bracket 34 may be divided, and the coupling member 61 and the coils 62 may be installed. In the case of the example shown in FIGS. 3 and 4, the wire harness is used as the vibration transmission member 33, and the wire harness cannot be divided to work properly. Therefore, it is desirable to adopt a configuration in which the first connector 31 or the second connector 32 is divided.

### 4. Further Application

The vibration generator 20 is described as an essential part (e-axle) for driving the electric vehicle 1 in the above examples. However, as a further application example, vibration generator 20 may be an electrically controlled device independent of the powertrain, which is intendedly installed to apply vibration to the vehicle body 10. For example, as the vibration generator 20, a vibrator 70 is attached to the body. If the vibrator 70 is controlled in cooperation with an operation input of the driver, the vibration caused by the acceleration can be reproduced.

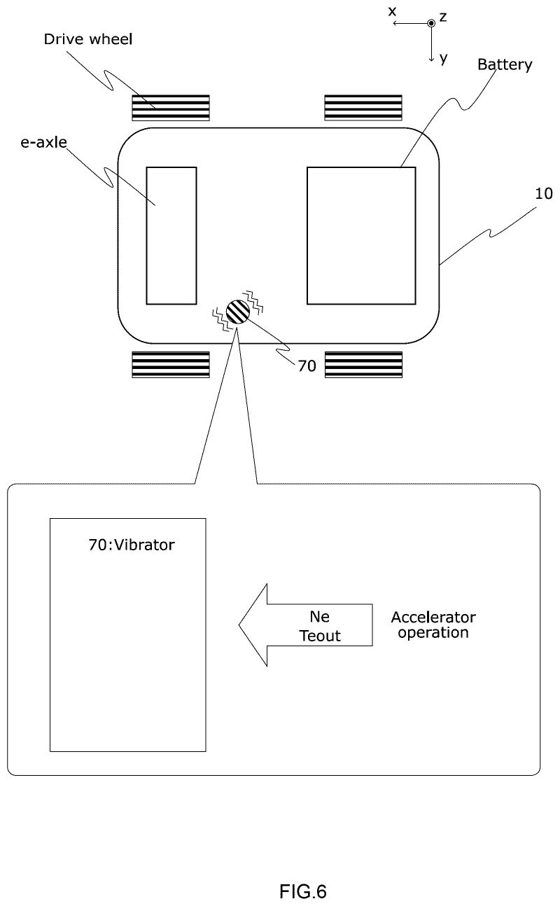

The above-described configuration is particularly effective when the electric vehicle 1 has the MT mode mentioned in Section 2. FIG. 6 is a schematic diagram showing a configuration in which the vibrator 70 is installed on the body of the electric vehicle 1 having the MT mode. In this case, in the electric vehicle 1, the virtual engine rotational speed Ne and the virtual engine output torque Teout are calculated in accordance with operation inputs such as an accelerator position Pap. By controlling the vibrator 70 in cooperation with the virtual engine rotational speed Ne and the virtual engine output torque Teout, the electric vehicle 1 can reproduce not only the driving characteristics of a general MT vehicle but also vibrations associated with acceleration and deceleration. Therefore, the driver of the electric vehicle 1 with the vibrator 70 feels attractive to more realistic reproduction of a MT vehicle. Therefore, mounting the vibrator 70 controlled in accordance with the operation input on the electric vehicle 1 having the MT mode can produce a synergistic effect.

What is claimed is:

1. An electric vehicle comprising:
a vibration generator mounted on a vehicle body via a vibration damping member; and
a vibration transmission path extending from the vibration generator to the vehicle body, without pathing through the vibration damping member.

2. The electric vehicle according to claim 1, further comprising a mount bracket connecting the vibration generator and the vibration damping member, wherein
the vibration transmission path connects the mount bracket and the vehicle body.

3. The electric vehicle according to claim 1, wherein
the vibration transmission path includes a vibration transmission member, a first connector, and a second connector,
the first connector connects the vibration transmission member and the vibration generator, and
the second connector connects the vibration transmission member and the vehicle body.

4. The electric vehicle according to claim 1, wherein
the vibration transmission path includes a first part, a second part, and a movable coupling member,
the first part and the second part are not in contact with each other,
the movable coupling member is contact with neither the first part nor the second part in a first state, and
the movable coupling member is contact with both the first part and the second part in a second state.

5. The electric vehicle according to claim 1, wherein
the vibration generator includes a motor that drives the electric vehicle.
